(19) United States
(12) Patent Application Publication
(10) Pub. No.: US 2003/0231646 A1
(43) Pub. Date: Dec. 18, 2003

(54) Method and system for efficient random packet enqueue, drop or mark processing in network traffic

(76) Inventors: Prashant R. Chandra, Sunnyvale, CA (US); Chee Keong Sim, Serendah (MY)

Correspondence Address: KENYON & KENYON, 1500 K STREET, N.W., SUITE 700, WASHINGTON, DC, 20005, US

(21) Appl. No.: 10/170,473

(22) Filed: Jun. 14, 2002

(51) Int. Cl. H04L 12/28; H04J 1/16

(52) U.S. Cl. 370/412; 370/229

(57) ABSTRACT

Embodiments of the present invention relate to improving the efficiency of packet enqueue, drop or mark processing in networks. Operations involved in computing an average queue size for making enqueue, drop or mark decisions utilize binary shift operations for computational efficiency. Operations used in computing a probability value used in making drop or mark decisions are also made more efficient.

### FIELD OF THE INVENTION

Embodiments of the present invention relate to a method and system for improving the efficiency of processing data packet traffic in a communication network, and more particularly to an improvement in a method and system for performing random packet enqueue, drop or mark decisions in a network device.

### BACKGROUND OF THE INVENTION

Data packet traffic in a communication network, such as the Internet, may be “bursty.” Bursty traffic is traffic that varies substantially in volume from one moment to the next in an unpredictable fashion, to the extent that network devices may not have the capacity to handle peak volumes in the traffic. One method of handling such unmanageable peak volumes is to randomly “drop” packets when traffic exceeds a threshold level. That is, rather than enqueuing a packet in order to process it and send it on to its destination, a network device may make the decision not to process the packet, in effect simply discarding or dropping it. Packets in unmanageable traffic may also be “marked.” A network device uses a marked packet to notify a traffic source that it is causing congestion at the network device, and to request the source to reduce the volume of traffic that it is sending to the device.

Known methods for implementing random packet drop include “Random Early Detection” (RED) and “Weighted Random Early Detection” (WRED). The RED and WRED methods, for example, may be implemented as code that executes in a network device. RED monitors network traffic in an effort to anticipate and avoid network congestion by tracking queue size at the network device, and making drop and mark decisions based on parameters including the queue size. WRED is similar to RED but is more sophisticated in that it takes the relative priorities of different traffic streams into account while managing network congestion.

Implementing random enqueue, drop or mark processing as done by RED and WRED is computation-intensive. Typically, for each packet that arrives at a network device that performs such processing, a series of computations must be performed, including calculating an average queue size and a probability value used in deciding whether to enqueue, drop or mark a packet. In current implementations, the computations performed by RED and WRED are expensive in terms of the computer resources required, because they involve, for example, table look-ups, generating random numbers, division and multiplication. Notwithstanding these demands, it is also necessary to maintain an acceptable quality of service, including good throughput, for network users.

In consideration of the above, a method and system are needed for increasing the efficiency of implementing random enqueue, drop or mark processing and reducing its cost.

### BRIEF DESCRIPTION OF THE DRAWINGS

FIG. 1 shows an example of a network wherein embodiments of the present invention could be advantageously used;

FIG. 2 shows a process flow for implementing WRED;

FIG. 3A shows one possible packet “drop probability” distribution as a function of average packet queue size;

FIG. 3B shows another possible packet “drop probability” distribution as a function of average packet queue size; and

FIG. 4 shows a process flow according to embodiments of the invention.

### DETAILED DESCRIPTION

Embodiments of the present invention may increase the efficiency and reduce the cost of implementing random enqueue, drop or mark decisions by simplifying the computations used, while maintaining or even increasing quality of service and network throughput. The embodiments replace computational operations typically performed in the existing art with equivalent operations that are substantially less expensive in terms of the computer resources needed for their implementation. More specifically, as outlined above, known implementations calculate an average queue size of packets in a queue at a network node; this average queue size is used in making an enqueue, drop or mark decision. In the form of the computation used when the queue is empty, known implementations utilize expensive table look-ups. By contrast, embodiments of the present invention may utilize at least one divide-by-power-of-two operation to determine average queue size when the queue is empty. Divide-by-power-of-two operations can be inexpensively implemented using binary shift-right operations. Additionally, embodiments of the present invention may utilize a stepped probability distribution to determine a “drop probability” used in making an enqueue, drop or mark decision. The stepped probability distribution can be efficiently searched using a binary search.

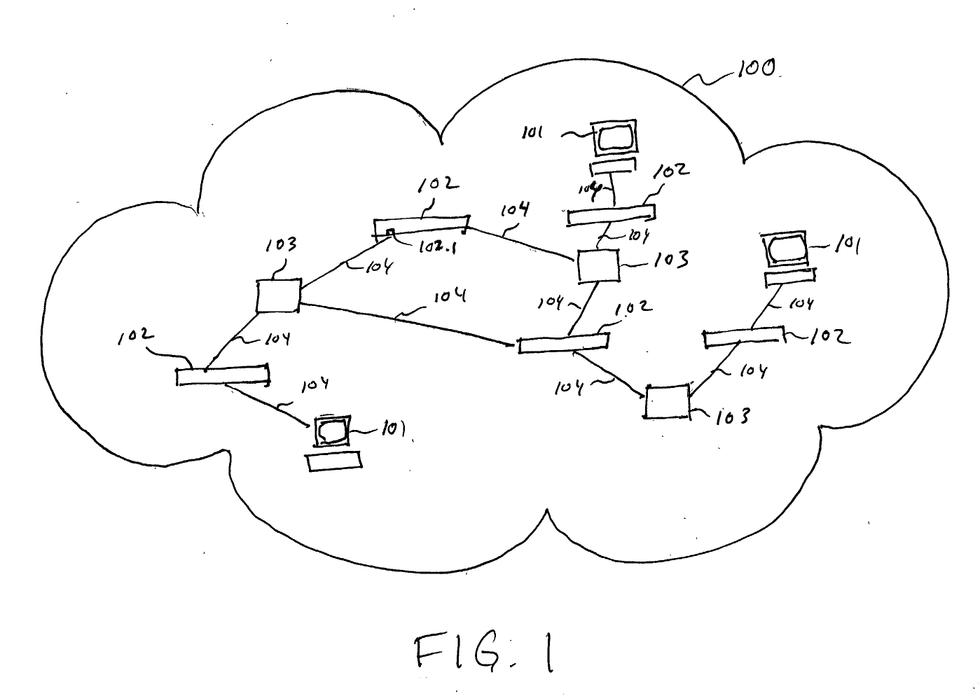

FIG. 1 shows an environment wherein embodiments of the present invention might find advantageous application. FIG. 1 illustrates a network 100 comprising users 101, network devices such as routers (gateways) 102, servers 103 and connections 104 therebetween. Connections 104 may be implemented via wired or wireless communication media. Requests by a user 101, for example, for information on a server 103 typically generates data packets directed from the user to the server, and data packets from the server to the user in reply to the request. Via connections 104, the packets typically pass through at least one network device that performs packet enqueue, drop or mark processing, such as a router 102, as the packets are propagated across the network to their respective destinations. A router 102 is responsible for ensuring that arriving packets are sent on to the proper destination.

A network device such as a router 102 may receive an arriving packet at an input port 102.1 coupled to communication medium 104. For each packet that arrives at a router, a decision must be made whether to enqueue the packet for subsequent processing to send it on to either another router or to its final destination, or to drop or mark the packet due to the inability to handle it because of heavy packet volume. As outlined above, such decision-making may be performed by computer-executable instructions executing on a router. More particularly, the instructions may be executed on a “blade” of the router. A blade is typically a thin, modular electronic circuit board that includes one or more microprocessors and memory, input and output ports, and peripheral devices specialized for network applications. A blade can be inserted into a space-saving rack with many similar blades. Because of space limitations, computational efficiency and efficient utilization of memory are naturally at a premium on a blade.

While, for illustrative purposes, routers have been discussed in some detail above as one example of network devices that perform packet enqueue, drop or mark processing, embodiments of the present invention are not limited to use in routers. Other kinds of network devices that perform packet enqueue, drop or mark processing include switches, firewalls, cable headends and DSLAMs (Digital Subscriber Line Access Multiplier)., and embodiments of the invention would find useful application in such devices as well.

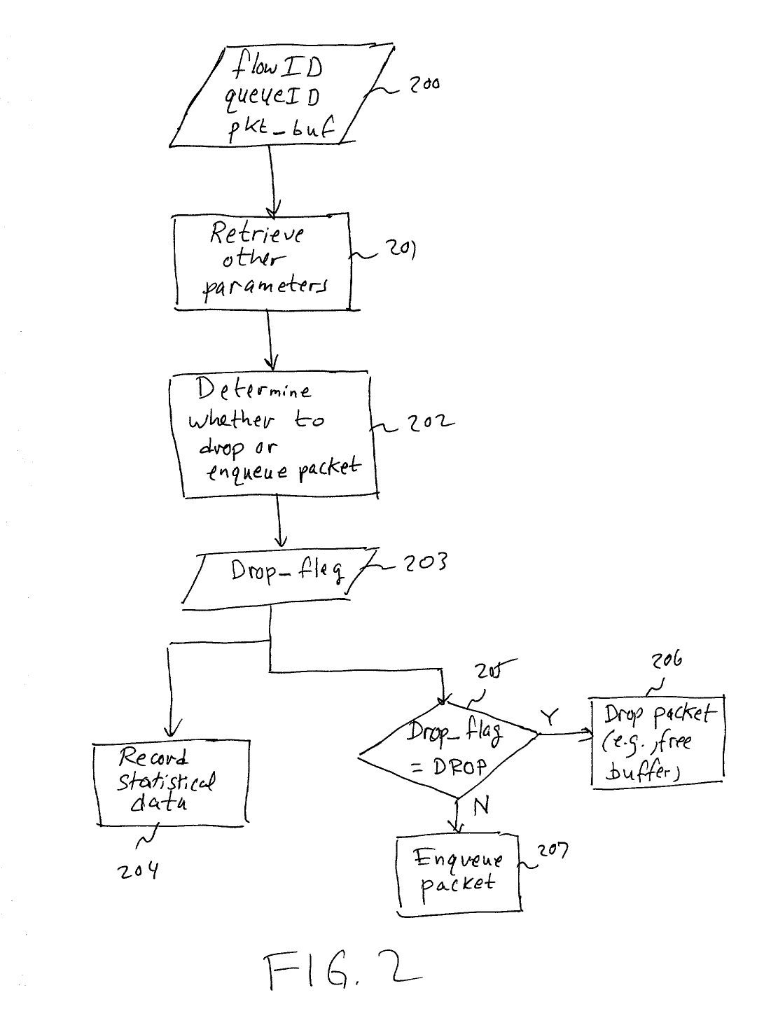

FIG. 2 shows a basic process flow for random drop processing as it may be currently performed, in particular by WRED. The process shown in FIG. 2 may be performed for each packet that arrives at a network device. Prior to entering the WRED flow, values may be assigned by earlier-executed software to parameters “flowID”, “queueID” and “pkt_buf”, which may be input to WRED as shown in block 200. (It is noted that parameter names and program structures as described herein are arbitrary and merely representative of functionality which could be implemented in any of a wide variety of computer instruction sequences. Hence, such are not be construed as limiting the embodiments of the invention disclosed.) The parameter “flowID” may denote an information stream comprising a sequence of packets that are in some way related; for example, the packets may be associated with the same sender and receiver. The parameter “flowID” may also contain information about the relative priority of the information stream as compared to other information streams being processed by the router. The parameter “queueID” denotes a particular queue, of a plurality of queues which may exist in a network device, associated with “flowID”. The parameter “pkt_buf” denotes the packet which is to be processed to decide whether to enqueue it by placing it in the queue identified by “queueID”, or to drop or mark it. (Hereinafter, to simplify explanation, only the drop operation will be referred to. It should be understood that while dropping a packet and marking a packet involve different operations, they are similar in that each may be performed due to heavy packet traffic as an alternative to enqueuing a packet.)

Block 201 represents an operation comprising retrieving other parameters used in making an enqueue or drop decision. Which parameters are retrieved may depend on a relative priority of an information stream as expressed in the “flowID” parameter. Examples of the other parameters include a “min_th” parameter, a “max_th” parameter, and a maxp_{b} parameter, respectively representing a minimum queue size threshold, a maximum queue size threshold, and a drop probability corresponding to the maximum queue size threshold. The meaning of these parameters and other parameters will be discussed in more detail later; for the present, it is merely observed that the parameters may then be input to a block 202 to determine whether to enqueue or drop the packet.

An output of block 202 may be a “drop_flag” 203, indicating a result of the determination of block 202. As shown in block 204, statistical data, such as how many packets have been dropped or enqueued within a given time period, may be recorded based on the value of “drop_flag”. Block 205 shows the result of the determination of block 202 being applied, by either dropping the packet as shown in block 206, or enqueuing it as shown in block 207. In practical terms, dropping the packet may involve freeing a buffer which had been used to temporarily store the packet. More generally, dropping a packet means freeing up all the resources that were consumed by that packet.

Table 1, below, shows an example of pseudo-code corresponding to block 202 of FIG. 2:

TABLE 1

| | |
|---|---|
| 1 | Initialization: |

| | |
|---|---|
| 2 | avg ← 0 |
| 3 | count ← −1 |

| | |
|---|---|
| 4 | for each packet arrival: |

| | |
|---|---|
| 5 | calculate the new average queue size avg: |

| | |
|---|---|
| 6 | if the queue is non-empty |

| | |
|---|---|
| 7 | avg ← avg + W_{q}(q − avg) |

| | |
|---|---|
| 8 | else using a table look-up: |

| | |
|---|---|
| 9 | avg ← (1 − W_{q})^{(time-q}^{_{—}}^{time)/s} ·avg |

| | |
|---|---|
| 10 | if minₜₕ < avg < maxₜₕ |

| | |
|---|---|
| 11 | increment count |
| 12 | p_{b} ← C1 · avg − C2 |
| 13 | if count > 0 and count ≧ Approx[R/p_{b}] |

| | |
|---|---|
| 14 | drop the arriving packet |
| 15 | count ← 0 |

| | |
|---|---|
| 16 | if count = 0 |

| | |
|---|---|
| 17 | R ← Random[0,1] |

| | |
|---|---|
| 18 | else if maxₜₕ < avg |

| | |
|---|---|
| 19 | drop the arriving packet |
| 20 | count < −1 |

| | |
|---|---|
| 21 | when queue becomes empty |

| | |
|---|---|
| 22 | q_time ← time |

Lines 1-3 of Table 1 represent initializing variables used in the determination of whether to enqueue or drop an arriving packet. The variable avg represents an average queue size that is newly calculated with each arriving packet. The variable count is used to track how many packets have been received since the last packet was dropped. Optimally, the dropping of packets is spaced out and only done randomly and intermittently, in order to avoid unduly impacting any one information stream. The count variable assists in this optimization operation.

Lines 5-9 show operations involved in calculating average queue size avg. As shown in line 10, once avg is calculated, it is determined whether avg is between a minimum queue size threshold minₜₕ and a maximum queue size threshold maxₜₕ. If avg is greater than maxₜₕ, the arriving packet is automatically dropped, and count is reinitialized (lines 18-19). If avg is less than or equal to minₜₕ, the arriving packet is automatically enqueued (line 10).

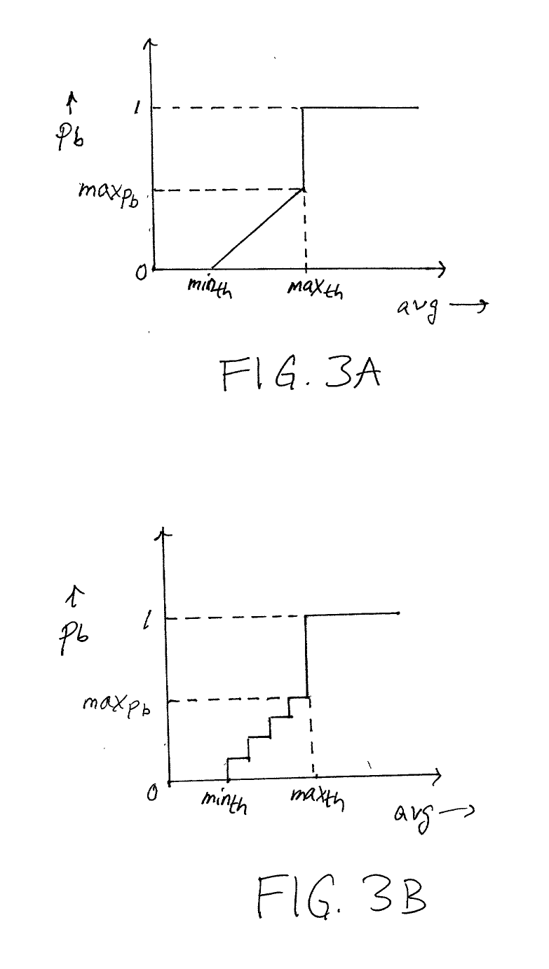

On the other hand, if the average queue size avg is between minₜₕ and maxₜₕ, further operations may be performed to determine whether to enqueue or drop the arriving packet (lines 10-17). The count variable may be incremented and a drop probability p_{b} calculated, using the operation p_{b}←C1·avg−C2 (lines 11-12). The drop probability p_{b} may be based on a linear probability distribution function as shown in FIG. 3A, which shows p_{b} as a function of average queue size avg. Thus, for example, referring to the values demarcating relevant points in the graph of FIG. 3A, C1 may be equal to maxp_{b}/(maxₜₕ−minₜₕ), and C2 may be equal to maxp_{b}·minₜₕ/(maxₜₕ·minₜₕ).

Then, it is decided whether to drop the packet based on the value of the count variable (line 13). If count is greater than zero and greater than or equal to Approx[R/p^{b}], where R is a random number between one and zero, and Approx is a function that converts a fraction to the nearest integer, the packet is dropped (line 14). Lines 15-17 show generating a new random number R each time a packet is dropped.

As noted earlier, embodiments of the present invention relate to improvements in the efficiency of the above calculations. Returning to Table 1, lines 8-9, if the queue is empty, the operation avg←(1−W_{q})^{(time-q}^{_{—}}^{time)/s}·avg is performed. Here, w_{q} is an averaging weight which may be an exponential function (1/2ⁿ), where n is the exponential weight factor. The parameter n may be chosen based on the speed with which the average queue size must track instantaneous variations in queue size, and is usually configured by a user/network administrator. The parameter q time is the time the queue became empty, and the parameter time is the current time. Thus, time−q_time is the period of time that the queue has been empty. The parameter s represents an average transmission time of a packet on a given link of the network. According to current methods, a table look-up must be performed to evaluate (1−w_{q})^{(time-q}^{₁₃} ^{time)/s}, which is expensive in terms of the computer resources needed. Embodiments of the present invention improve upon the efficiency of the operation of calculating the average queue size avg, and in particular upon the operation shown in line 9, i.e., the calculation of average queue size when the queue is empty.

Further, embodiments of the invention improve upon the efficiency of calculating the p_{b} value corresponding to the calculated average queue.

An improvement in the efficiency of the calculation of average queue size when the queue is empty will be discussed first. An improvement lies in the recognition that the calculation avg←(1−w_{q})^{(time-q}^{_{—}}^{time)/s·}avg, which, as noted above, requires a table look-up to evaluate (1−w_{q})^{(time-q}^{_{—}}^{time)/s}, may be replaced by a much simpler calculation. In the simpler calculation, the evaluation of (1−w_{q})^{(time-q}^{_{—}}^{time)/s} uses at least one “divide-by-power-of-two” operation instead of a table look-up. Divide-by-power-of-two operations, as is well known, can be implemented in a computer by simple binary shift-right operations. A binary shift-right operation is substantially less costly in terms of the computer resources required than is a table look-up.

More specifically, in embodiments of the invention, calculation of the average queue size avg when the queue is empty may be implemented (within given constraints) as:

Expression 1:

avg←avg>>f(m,n)=avg>>[(m+(m>>1))>>n], where avg is average queue size as before, m=(time−q_time)/s, n is the exponentional weight factor as before, and the operation “>>” indicates “binary shift right”; thus, for example, “>>n” means “shift right by n bits.”

Table 2, below, shows that (1−w_{q})^{(time-q}^{_{—}}^{time)/s}=(1−(1/2)ⁿ)^{m} may be approximated using divide-by-power-of-two operations.

TABLE 2

| | |
|---|---|
| 1 | (1 − (1/2)ⁿ)^{m} = (1/2)^{r} |
| 2 | → m In(1 − (1/2)ⁿ) = r In(1/2) |
| 3 | → m In(1 − (1/2)ⁿ) = r In(2) |
| 4 | → = 1.44 · m In(1 − (1/2)ⁿ) = r |

It is well known that ln(1+x)=x−(x²)/2+(x)³— . . . for (−1<x≦1). Here, since x=−(1/2)ⁿ, it is reasonable to use the approximation ln(1+x)=x (discarding the terms—(x²)/2+(x)³—. . . ), especially as n increases positively. Thus, r can be approximated as 1.5·m/2ⁿ, demonstrating that (1−w_{q})^{(time-q}^{_{—}}^{time)/s}=(1−(1/2)ⁿ)^{m} can be approximated using divide-by-power-of-two operations, which can be efficiently implemented as binary shift-right operations in a computer. More specifically, returning to line 9 of Table 1, avg←(1−w_{q})^{(time-q}^{_{—}}^{time)/s}·avg may, in view of the above, be approximated as avg←(1/2)^{r}·avg=avg>>r. Using the approximation r=1.5·m/2ⁿ=(m+m/2)/2ⁿ=(m+m>>1)>>n, the expression shown in Expression 1, above, is arrived at. Since the evaluation of Expression 1 involves only addition and binary shift-right operations, a substantial improvement in efficiency over existing methods is realized.

The average queue size calculated as avg ←avg>>f(m,n)=avg>>[(m+(m>>1))>>n] according to embodiments of the invention may then be used as described in connection with Table 1. That is, depending upon the value of avg calculated relative to minₜₕ and maxₜₕ, an arriving packet may be either enqueued, dropped or marked.

Other calculations involved in calculating avg←avg>>f(m,n)=avg>>[(m+(m>>1))>>n] include, of course, the calculation of m=(time−q_time)/s, which in turn requires the calculation of s. Because average queue size is typically only calculated when a new packet is received, the parameter s may be used in an effort to predict a reduction or decay in the average queue size that occurred while the queue was idle. As noted above, s represents an average transmission time for a packet on a given link. Here, “link” refers to a communication path between any two nodes of a network and “transmission time” refers to the time required to transmit a packet over the link.

The calculation of m=(time—q_time)/s may also be efficiently made using divide-by-power-of-two operations according to embodiments of the invention. More specifically, a value x may be found such that m=(time−q_time)/s may be approximated by (time—q_time)/2^{x}=(time−q_time)>>x. As explained above, (time−q_time) represents the duration of time the queue was empty. In processors used in network devices that perform packet drop and mark operations, a cycle counter of the processor may be used to measure (time−q_time)

The improvements in the efficiency of calculating the p_{b} corresponding the calculated average queue size will be discussed next.

As discussed previously, enqueue, drop or mark decisions may be made based on a probability computation, as shown in lines 12 and 13 of Table 1, repeated below:

12 p_{b}←C1·avg−C2

13 if count>0 and count≧Approx[R/p_{b}]

The computation on line 12 involves a multiplication operation (C1·avg) followed by an add operation (−C2). Recalling that p_{b}=C1·avg−C2 corresponds to the graph shown in FIG. 3A, the operation in line 12 corresponds to projecting a value of avg that falls between minₜₕ and maxₜₕ onto the p_{b} axis. Then, the value for p_{b} found in line 12 must be divided into R, as shown in line 13 (R/p_{b}).

According to embodiments of the invention, the operation shown in line 12 may be replaced by an operation that uses a stepwise distribution Of p_{b} and a binary search instead. The binary search can be performed more quickly and efficiently than the multiply-then-add operation of line 12. More specifically, a probability distribution for p_{b} may be derived which is stepwise as shown in FIG. 3B, rather than linear as in FIG. 3A. The probability distribution shown in FIG. 3B pairs or correlates discrete, “stepped” values of p_{b} with subsets of the range minₜₕ<avg <maxₜₕ. Though the example of FIG. 3B shows 4 steps between minₜₕ and maxₜₕ, the number of steps, and how finely the steps are graduated is arbitrary. For example, 8 steps could provide acceptable accuracy, but 16 or more steps could be utilized for finer resolution.

Once a value for avg has been determined, a corresponding p_{b} value could be efficiently determined using a binary search of the stepwise probability distribution. As is well known, a binary search divides a range to be searched into halves, successively. Using a binary search, it could be determined where within the range minₜₕ<avg<maxₜₕ that the value of avg determined fell. Then, because each subset of the range minₜₕ<avg<maxₜₕ corresponds to a stepped p_{b} value, as shown in the example of FIG. 3B, the possible values of p_{b} would be successively limited as the range of avg was narrowed down. For example, using a binary search, it could be determined that avg fell in the upper half of the range minₜₕ<avg<maxₜₕ. Recalling that maxp_{b}, is the drop probability corresponding to maxₜₕ, this would limit the possible values of p_{b} to maxp_{b}/2<p_{b}<maxp_{b}. Then, it would be determined which half of that upper half of minₜₕ<avg<maxₜₕ avg belonged in, which would again restrict the possible values of p_{b}, and so on. Thus, while the location of avg within the range minₜₕ<avg<maxₜₕ is being determined, at the same time the corresponding value of p_{b} is also determined between 0 and maxp_{b}. Therefore, once the correct range of avg is obtained, the corresponding value of p_{b} is obtained automatically. The operations of the binary search, since they involve divide-by-power-of-two operations, could be implemented using binary shift-right operations.

Advantageously, the values correlated with avg in a stepwise distribution could be ¹/p_{b} rather than p_{b}, SO that the calculation of R/p_{b} could be performed by multiplication rather than division. Multiplication is significantly faster than division computationally, and in particularly in a network device without hardware support for either multiplication or division.

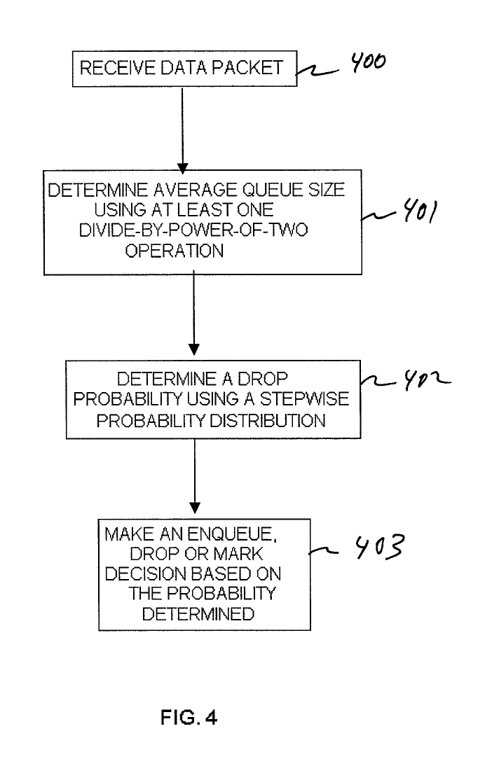

In light of the foregoing description, FIG. 4 shows a process flow according to embodiments of the invention. As shown in block 400, a packet may be received at a device that performs packet enqueue, drop or mark processing. In order to make an enqueue, drop or mark decision, an average queue size may then be determined. In particular, if the queue is empty, the average queue size may be determined using at least one divide-by-power-of-two-operation, as shown in block 401. The divide-by-power-of-two-operations may be implemented using binary shift-right operations.

When the average queue size has been determined, a drop probability used in making an enqueue, drop or mark decision may then be determined, as shown in block 402. The drop probability may depend on the average queue size computed. In particular, the drop probability may be found by a search in a stepwise probability distribution that correlates discrete probability values with subsets of a range of the average queue size. A packet enqueue, drop or mark decision may then be made based on the drop probability determined, as shown in block 403.

As described earlier, embodiments of the invention may be implemented in computer-executable instructions that execute on a network device. To that end, the device may comprise one or more microprocessors and memory, input and output ports, and peripheral devices. The computer-executable instructions may be stored and transported on computer-usable media such as diskettes, CD-ROMs, magnetic tape or hard disk. The instructions may be retrieved from the media and executed by a processor to effect a method according to embodiments of the invention.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method for making one of a packet enqueue, drop and mark decision in a network, comprising:
receiving a data packet at a node of a network;
determining an average queue size of packets in a queue at said node, wherein when said queue is empty, said average queue size is determined using at least one divide-by-power-of-two operation; and
making one of a packet enqueue, drop and mark decision based on said average queue size.

2. The method of claim 1, wherein said divide-by-power-of-two operation is implemented using at least one binary shift-right operation.

3. The method of claim 1, wherein said divide-by-power-two operation is used in the evaluation of (1/2)^{r}, where r is approximately equal to 1.5·m/2ⁿ, m=(a period of time said queue has been empty)/s, s represents an average transmission time of a packet on a given link of said network, and n is a positive integer.

4. The method of claim 3, wherein (1/2)^{r} is an approximation of (1−(1/2)ⁿ)^{m}.

5. The method of claim 2, wherein said at least one binary shift-right operation is used to implement avg←avg>>[(m+(m>>1))>>n], where avg is said average queue size, m=(a period of time said queue has been empty)/s, s represents an average transmission time of a packet on a given link of said network, and n is a positive integer.

6. The method of claim 1, wherein said divide-by-power-of-two operation is an approximation of avg←(1−w_{q})^{(time-q}^{_{—}}^{time)/s}·avg, where avg is said average queue size, w_{q} is an averaging weight, q_time is a time the queue became empty, time is a current time, and s represents an average transmission time of a packet on a given link of said network.

7. The method of claim 1, further comprising determining a probability used to make said decision.

8. The method of claim 7, wherein said probability is correlated with said average queue size.

9. The method of claim 7, wherein said probability is based on a stepwise distribution.

10. The method of claim 7, wherein said determining comprises performing a binary search in a stepwise probability distribution that correlates discrete probability values with subsets of a range of said average queue size.

11. A network device comprising:
an input port couplable to a communication medium; and
computer-executable instructions configured to make one of an enqueue, drop and mark decision with respect to a packet arriving via said communication medium at said input port, said instructions being configured to compute an average queue size of packets in a queue of said network device, wherein when said queue is empty, said average queue size is computed using at least one divide-by-power-of-two operation.

12. The network device of claim 11, wherein said divide-by-power-of-two operation is implemented using at least one binary shift-right operation.

13. The network device of claim 11, wherein said divide-by-power-two operation is used in the evaluation of (1/2)^{r}, where r is approximately equal to 1.5·m/2ⁿ, m=(a period of time said queue has been empty)/s, s represents an average transmission time of a packet on a given link of said network, and n is a positive integer.

14. The network device of claim 11, wherein said at least one binary shift-right operation is used to implement avg←avg>>[(m+(m>>1))>>n], where avg is said average queue size, m=(a period of time said queue has been empty)/s, s represents an average transmission time of a packet on a given link of said network, and n is a positive integer.

15. The network device of claim 11, said computer-executable instructions being further configured to determine a probability used to make said decision.

16. The network device of claim 15, said computer-executable instructions being further configured to perform a binary search in a stepwise probability distribution that correlates discrete probability values with subsets of a range of said average queue size to determine said probability.

17. A computer-usable medium storing computer-executable instructions, said instructions when executed implementing a process comprising:
receiving a data packet at a node of a network;
determining an average queue size of packets in a queue at said node, wherein when said queue is empty, said average queue size is determined using at least one divide-by-power-of-two operation; and
making one of a packet enqueue, drop and mark decision based on said average queue size.

18. The computer-usable medium of claim 17, wherein said divide-by-power-of-two operation is implemented using at least one binary shift-right operation.

19. The computer-usable medium of claim 18, wherein said at least one binary shift-right operation is used to implement avg←avg>>[(m+(m>>1))>>n], where avg is said average queue size, m=(a period of time said queue has been empty)/s, s represents an average transmission time of a packet on a given link of said network, and n is a positive integer

20. The computer-usable medium of claim 17, said process further comprising performing a binary search in a stepwise probability distribution that correlates discrete probability values with subsets of a range of said average queue size to determine a probability used to make said decision.
